(19) United States
(12) Patent Application Publication
(10) Pub. No.: US 2007/0113440 A1
(43) Pub. Date: May 24, 2007

(54) Electroluminescent sign

(76) Inventor: Farshid H. Asvadi, Lexington, KY (US)

Correspondence Address: F. ASVADI, PO BOX 24886, LEXINGTON, KY, 40524, US

(21) Appl. No.: 11/650,078

(22) Filed: Jan. 5, 2007

Related U.S. Application Data
(63) Continuation-in-part of application No. 10/712,719, filed on Nov. 13, 2003, now abandoned.

(51) Int. Cl. G09F 13/22

(52) U.S. Cl. 40/544

(57) ABSTRACT

Disclosed is a robust, flexible, immersible, self contained electroluminescent sign that is resistant to the natural elements and readily mobile.

### PRIORITY

Priority is claimed on the basis of provisional application No. 60/426,250, filed Nov. 13, 2002, and nonprovisional application Ser. No. 10/712,719, filed Nov. 13, 2003, with respect to the latter of which the present application is a continuation-in-part, and each of which is hereby fully incorporated by reference in its entirety.

### BACKGROUND OF THE INVENTION

This invention relates to a flexible self contained back lit or custom tailored sign that uses electroluminescence as a source of light. Although there has been many prior arts relating and employing electroluminescent lighting, the need for a portable, self contained sign that is easily portable exists. Examples of such previous arts include U.S. Pat. No. 4,195.431 to Neufeld, U.S. Pat. No. 5,005,306 to Kinstler and in U.S. Pat. No. 5,566,384 to Chien. U.S. Pat. No. 4,999,936 Calamia. Portability has been a major obstacle in the electroluminescence field when large areas of the electroluminescent sheet are to be lit. Heat exhaustion and lack of sufficient power has largely limited the usages of this type of sign to hard wired units that are attached to permanent power supplies or have limitations in use due to lack of flexibility or the potential exposure to the natural elements. This problem was eliminated by using a watertight tube attached to a flexible electroluminescent sheet that could accommodate the power supply and the circuitry, yet made of materials to act as a heat sink to disperse the extreme heat created by the inversion circuitry when powering large panels of electroluminescent sheets. This tube would also accommodate the battery pack to energize the circuitry needed to energize the Electroluminescent sheet and could accommodate a microprocessor to have the sign illuminated in segments in a pre-programmed sequence.

### STATEMENT REGARDING FEDERAL SPONSORSHIP

Not applicable

### FIELD OF THE INVENTION

The invention relates to a fully mobile, flexible, waterproof electroluminescent sign.

### BRIEF DESCRIPTION OF THE DRAWINGS

FIG. 1 is a perspective view of an embodiment [100] in which a single cylindrical tube contains the battery or batteries, the inversion circuitry and is in contact with a planar sheet of electroluminescent material that is disposed between parallel layers of flexible laminate material.

FIG. 2 is a view of the embodiment [100] depicted in FIG. 1 with the printed or custom artwork inserted in front [220].

FIG. 2a is a detailed view of circuitry [280], the onboard transformer [281] and the transformer winding [281], together with the batteries [260], housed in heat sink/cooling tube [210].

FIG. 2b is a detailed view of electroluminescent sheet [212], securing plate [214] and the flexible magnet [213] attached to the cooling tube [210] using screws [211]. Inversion/control circuitry [280] and the onboard transformer [281] are connected to the electroluminescent sheet using spring connectors [230]. The power pack [260] and the winding of the transformer [282] are also housed in the heat sink/cooling tube [210].

FIG. 3 is a back view of the embodiment [100] depicted in FIG. 1.

FIG. 4 is a top view of the embodiment [100] depicted in FIG. 1.

FIG. 5 is a bottom view of the embodiment [100] depicted in FIG. 1.

FIG. 6 is a left view of the embodiment [100] depicted in FIG. 1.

FIG. 7 is a right view of the embodiment [100] depicted in FIG. 1.

FIG. 8 is a perspective view of an embodiment [100] in which two cylindrical heat sink/cooling tubes [210] contain the batteries and are in contact with a planar sheet of electroluminescent material.

FIG. 9 is a perspective view of the embodiment [100] rolled up for easy storage

FIG. 9a is a perspective view of the embodiment [100] rolled up in a storage tube [920], with the lid [921] in place and shipping/storing label [922] for easy shipping and handling.

FIG. 9b is a perspective view of the embodiment's [100] flexibility characteristics

FIG. 10 is a perspective view of the embodiment [100] used as a self contained, portable vehicular [1020] sign [0018]

FIG. 10a is a perspective view of the embodiment [100] attachment process when used as a self contained, portable vehicular [1020] sign [0019]

FIG. 10b is a perspective view of the embodiment [100] used as a self contained, portable marine/boat [1040] sign

FIG. 11 is a perspective view of the embodiment [100] placed on a tripod [1120] used as a self contained, portable warning/road sign

FIG. 12a is a perspective view of the embodiment [100] used as a self contained, portable decorative sign

FIG. 12b is a perspective view of the embodiment [100] used as a self contained, portable decorative sign

FIG. 12c is a perspective view of the embodiment [100] used as a self contained, portable sign segmented to be connected to a microprocessor to light up the segments [1220] is a programmed sequence.

FIG. 13 is a perspective view of the embodiment [100] used as self contained, portable waterproof warning or message sign

FIG. 14 is a perspective view of the embodiment [100] place in a charging cradle while not in use

FIG. 14a is perspective view of the heat sink/cooling tube [210], the inversion circuitry [280] and the mounted transformer [281] and the winding [282], power pack [260], ON/OFF switch [1441], rubber membrane [1442] and [1445], charging circuit connectors [1446] and [1447] and the spring connectors [230], connecting the tube assembly [210] to the Electroluminescent sheet [212].

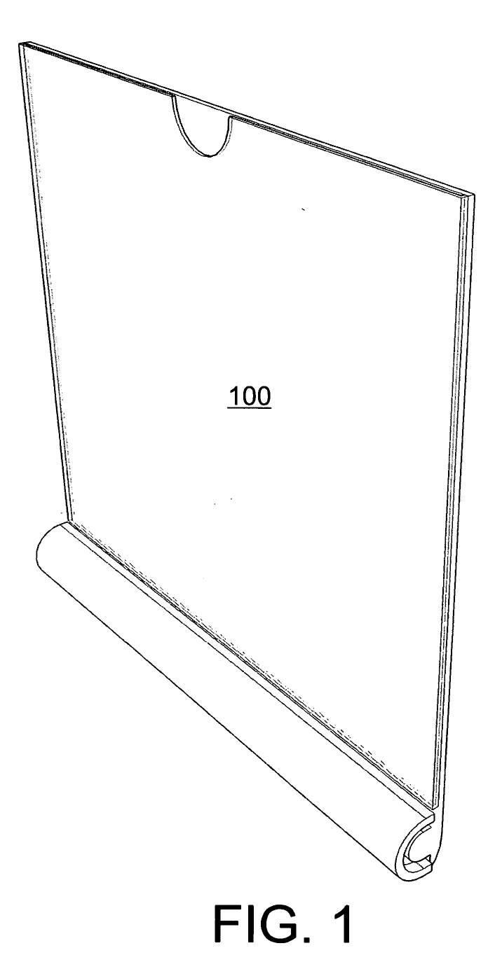

### DESCRIPTION OF THE INVENTION

The invention provides a robust, flexible and versatile electroluminescent sign that is readily mobile.

The invention relates to a flexible, lightweight fully portable, rechargeable but robust sign that is easily visible under conditions of reduced ambient lighting.

In an embodiment, a sheet of electroluminescent (EL) material was sandwiched between two layers of flexible laminate, the electroluminescent material being subject to excitement by an AC current. Two electrical conductors were placed in contact with the electroluminescent sheet. An inversion circuit board (providing for output of AC current from input of DC current) was placed in contact with the two conductors. When a switch is closed, the inversion circuit board was placed in contact with a power pack/batteries; DC current flowed from the batteries to the circuit board, which produced an AC current (and hence luminescence) in the electroluminescent material to which the circuit board was connected via the springs and the conductors. The power pack and the circuitry are housed in a watertight tube also acting as a heat sink to keep the internal components cool and dry.

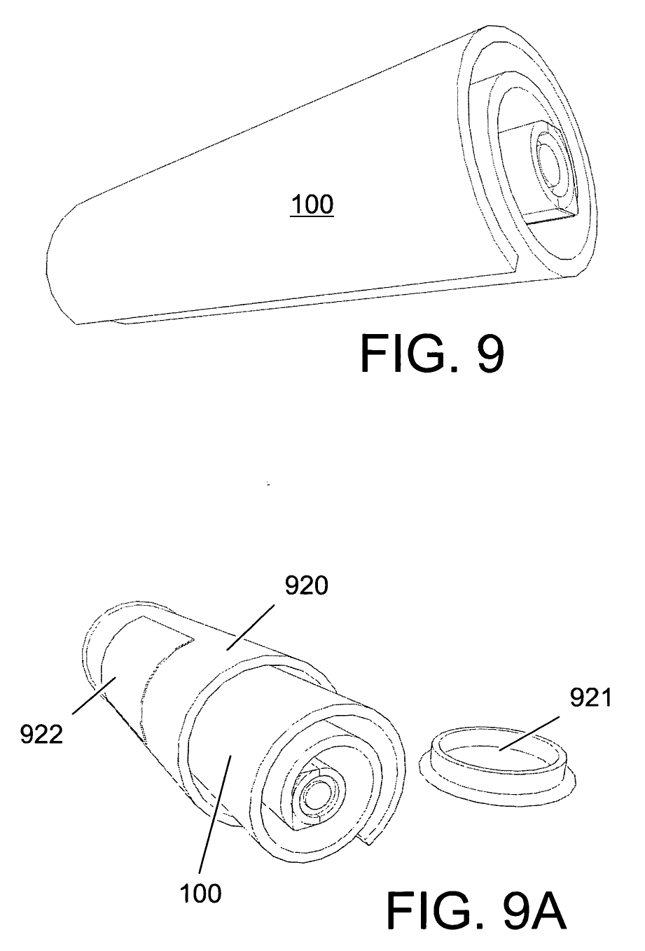

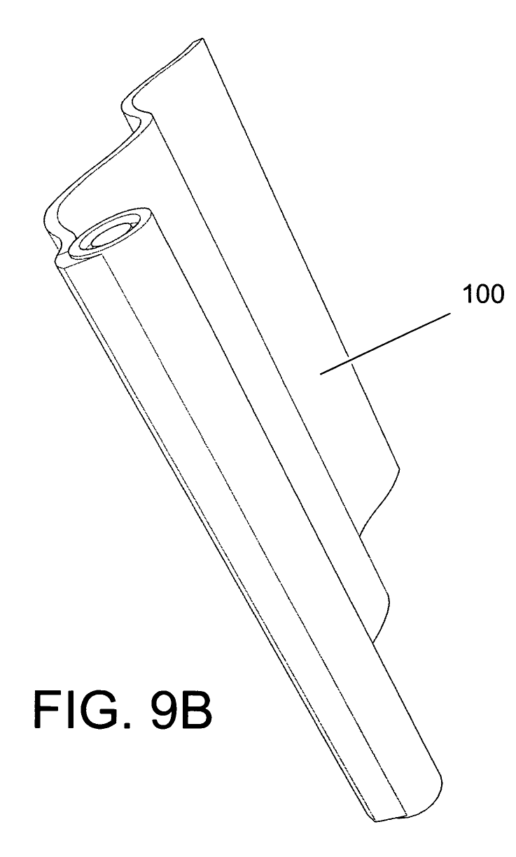

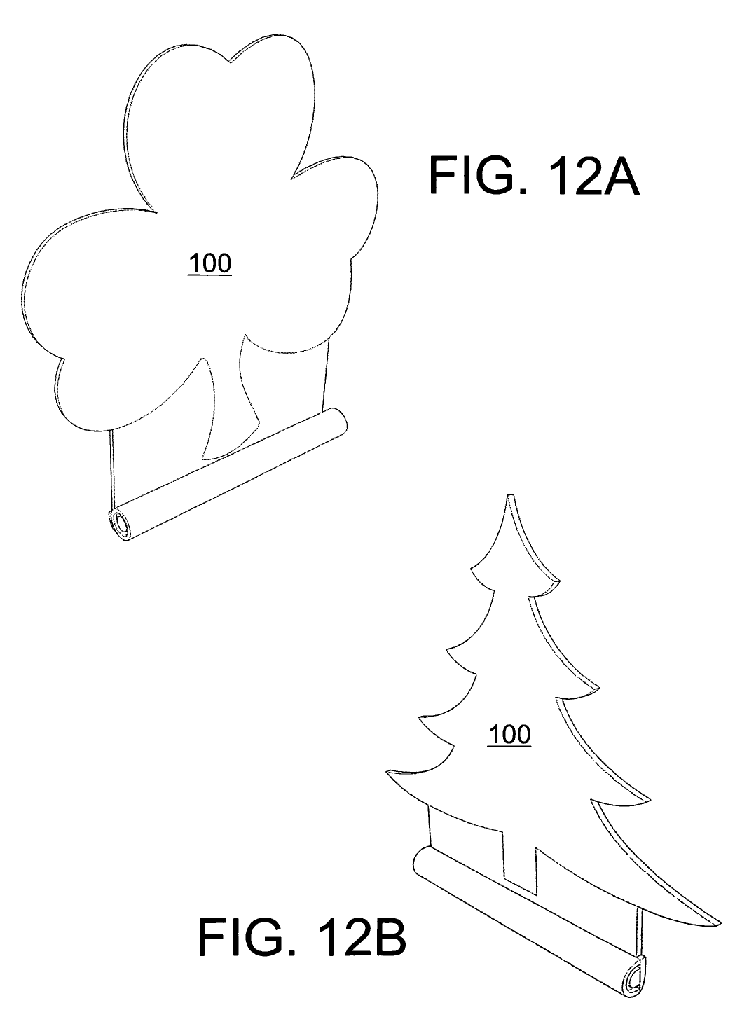

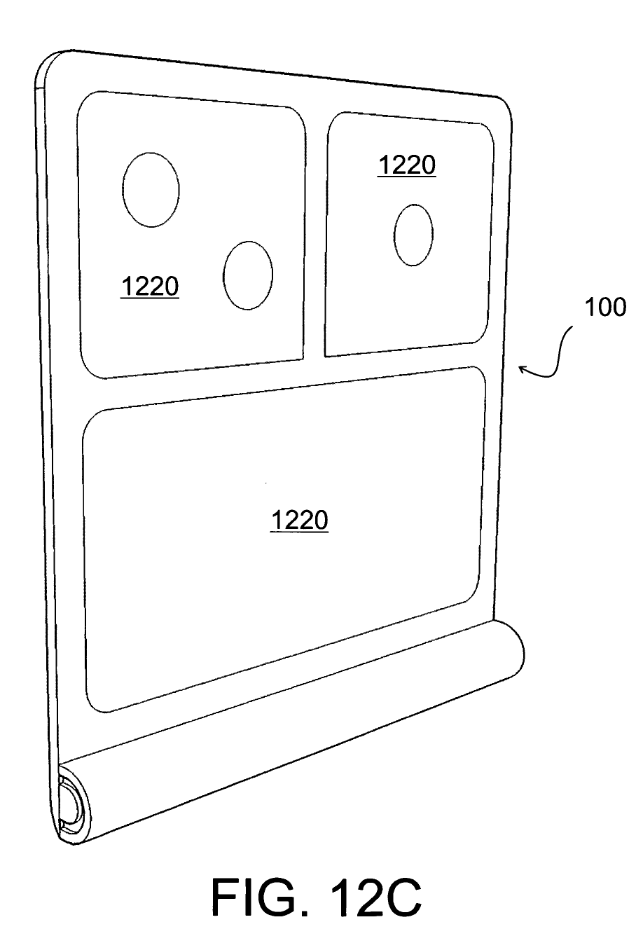

In another embodiment, some of the switching was done electronically using a microprocessor in order to obtain a mode of display in which the image was segmented and each segment was energized in a pre-programmed sequence to create a dancing display effect. This example is illustrated in FIG. 12c where the dots are connected individually to a microprocessor which is accommodated as part of the inversion circuitry. A flexible magnet was placed at the back of the display so it could easily be attached or peeled from any metal surface with ease. The sign would simply be rolled and be stored inside a tube as shown in FIG. 9a. A battery or batteries or a suitable power pack, serving as power supply to supply power to the inversion circuit, were housed in one or two tubes accommodating the batteries. Two tubes were used when extended illumination time was required, such as long distance delivery vehicles where access to a charging cradle is limited. The unit is placed is a charging cradle when not in use.

### DETAILED DESCRIPTION OF THE DRAWINGS

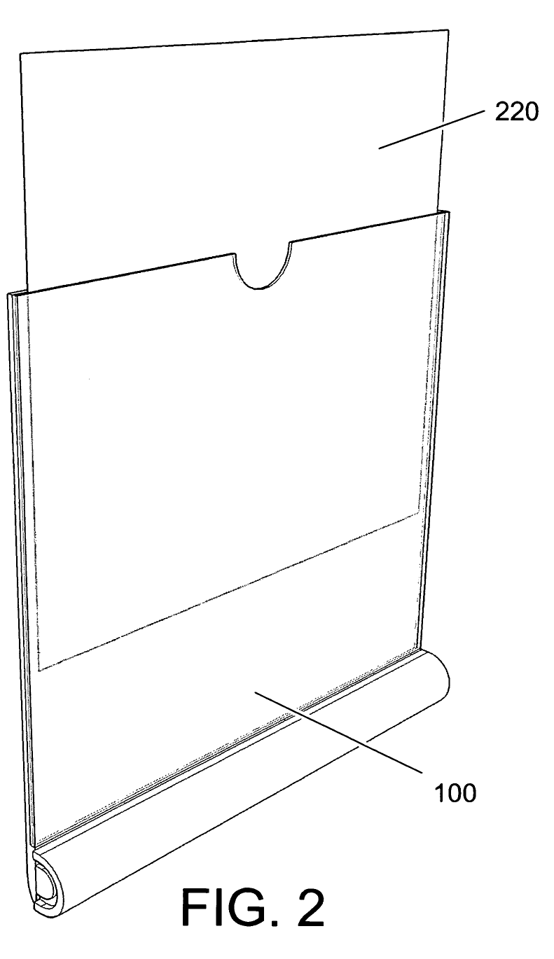

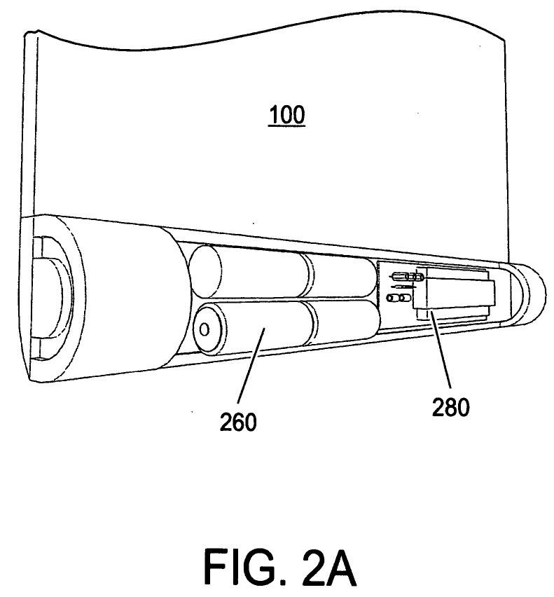

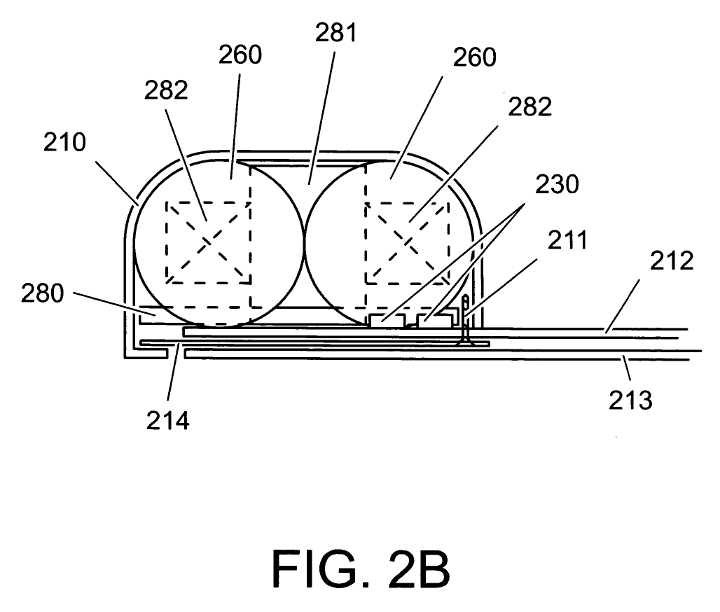

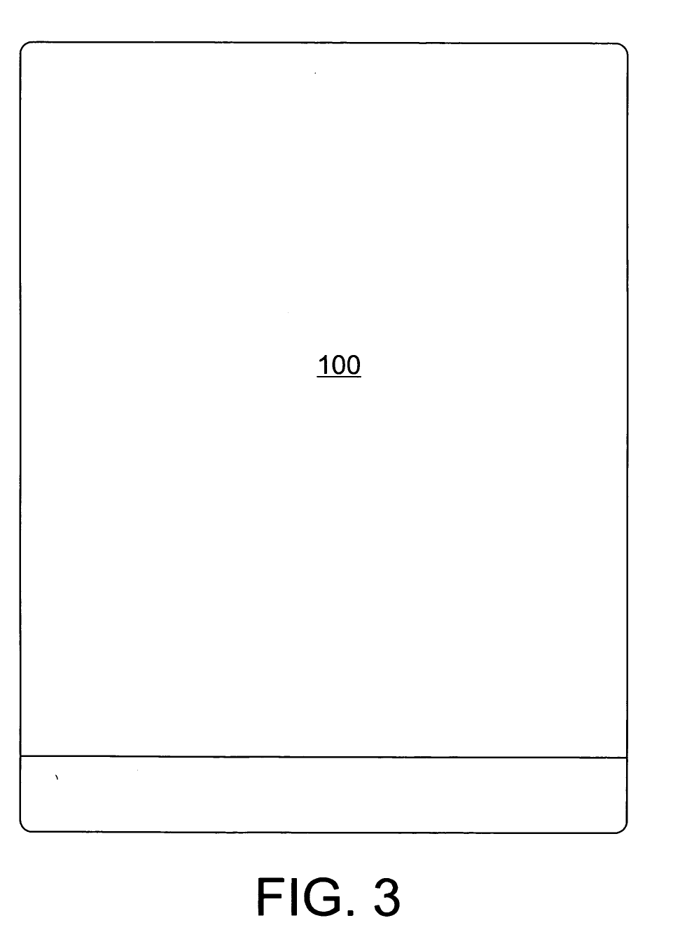

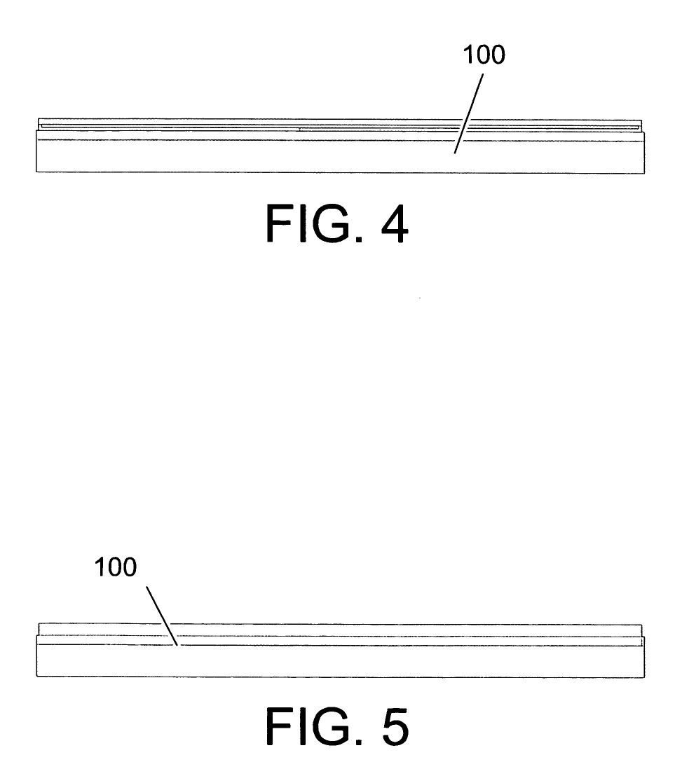

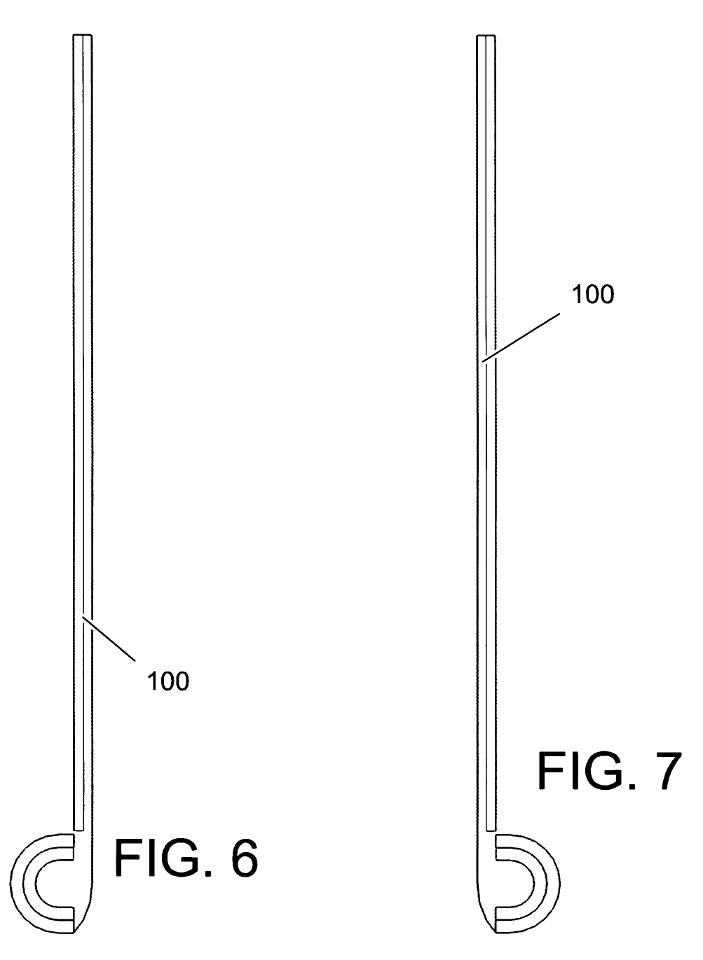

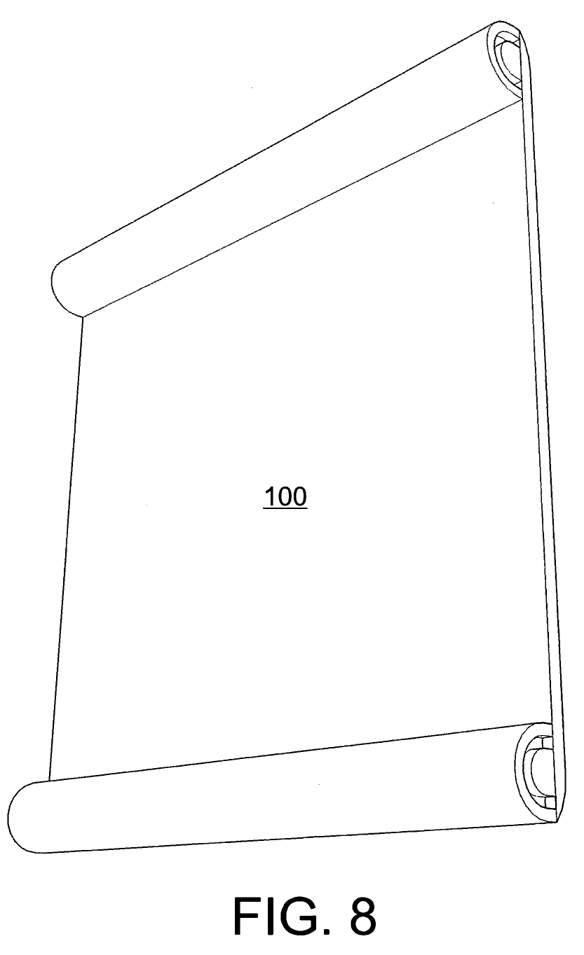

In an example of an embodiment the invention (see FIGS. 2a and 2b), a planar sheet of Electroluminescent material was placed between two planar sheets of flexible laminate. The three sheets, running in parallel, as a sandwich, were affixed to a right cylindrical heat sink/cooling tube [210]. Within the cylindrical tube a rechargeable power pack [260] and voltage inversion circuitry [280] is placed. A sequence controller microprocessor can also be incorporated into this circuitry to create a specific pattern or sequence of light. The sheet is secured in place by means of an adhesive applied to securing plate [214] and screws [211]. Silicone is applied all round the body of the tube [210]. A switch was placed underneath a rubber membrane at the end of the tube. When this switch is closed, voltage is induced to luminescence through two connectors [230] by means of two small springs mounted on the inversion circuit connecting the electroluminescent sheet's terminals to the output of the circuit board, allowing current to flow to the electroluminescent material and/or specific segments. The transformer [281] and its winding coil [282] onboard the inversion circuit board [280] produce a lot of heat which is dissipated through the heat sink/cooling tube [210]. A flexible self adhesive magnet [213] is attached to the back of the sheet [212] to allow the complete unit to attach to any metal surface with ease.

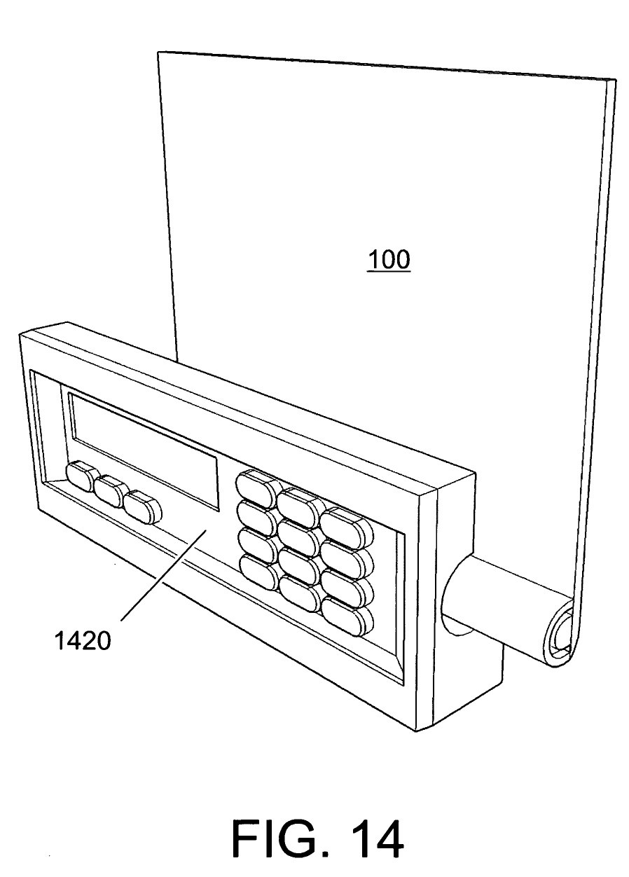

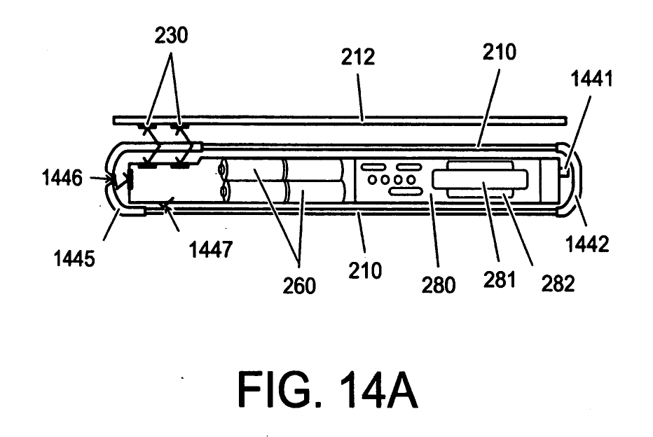

The heat sink/cooling tube assembly in FIG. 14a consists of inversion circuitry [280] and the power pack [260]. Charging is achieved by grounding (negative charge) the body of the heat sink/cooling tube [210] via connector [1447] and the positive charge point of [1446] which makes connection when the tube is placed in the charging cradle. ON/OFF switch [1141] close the circuit to provide voltage to the inversion circuit board [280] hence powering up the electroluminescent sheet [212] via the spring connectors [230]. The two rubber membranes on both sides of the tube [210] provide a watertight, sealed cap for the cooling tube [210].

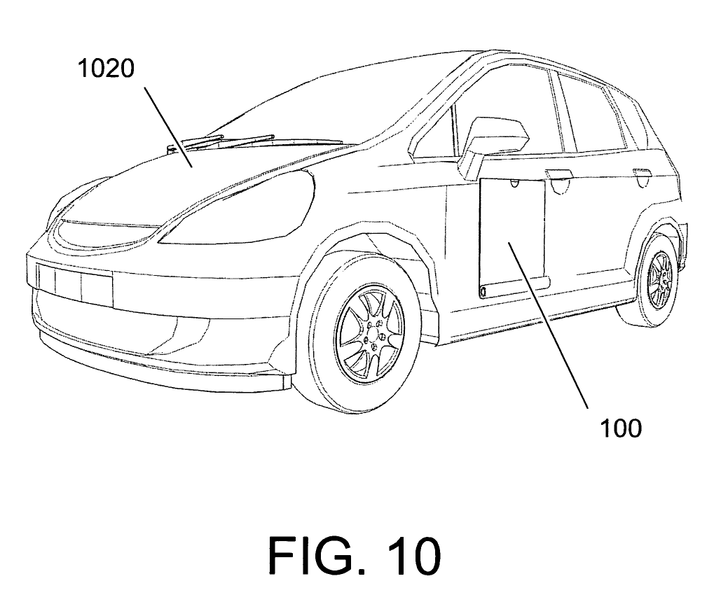

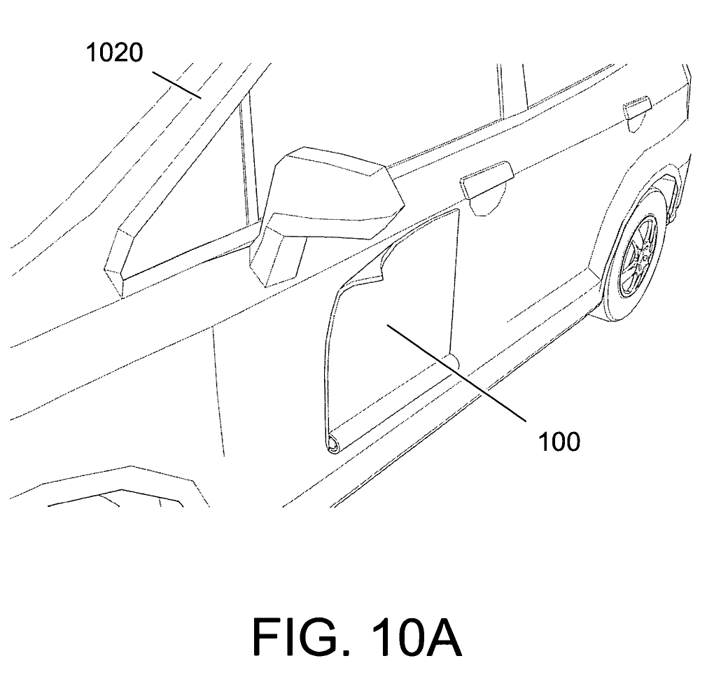

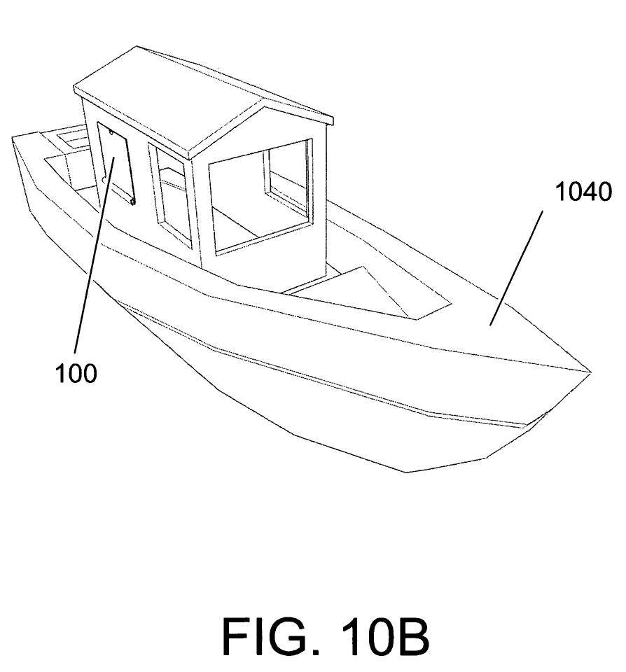

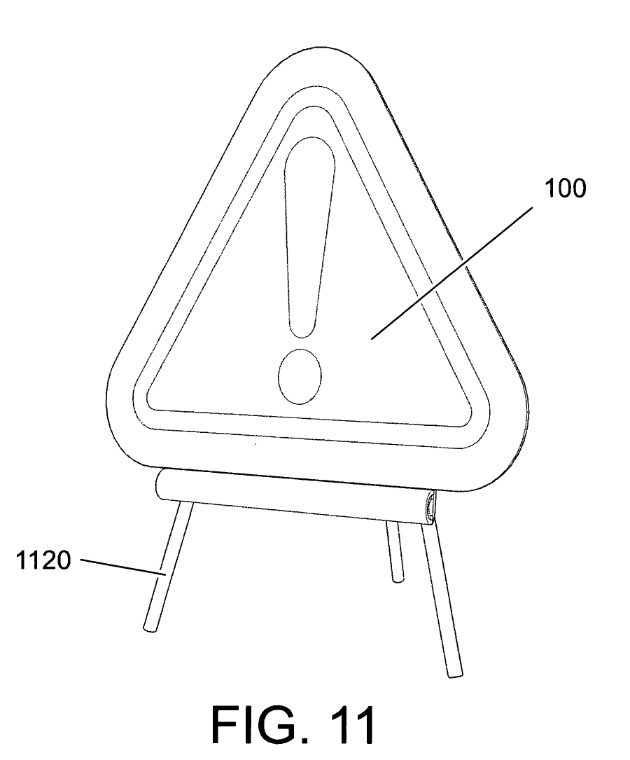

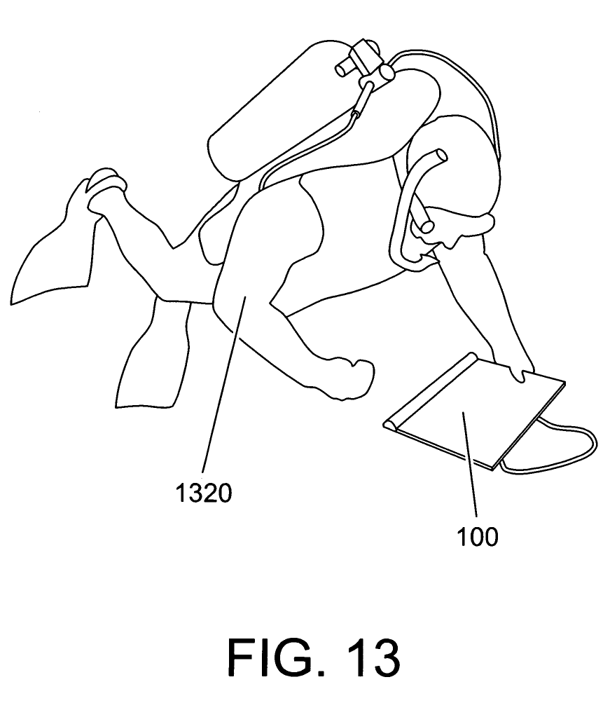

A sign according to the invention is readily mobile, permitting the sign to be used in a vast variety of applications: as a handheld sign [FIG. 13]; as a promotional display sign (e.g. used in exhibitions); as a domestic sign (e.g. Christmas or Halloween sign, FIGS. 12a and 12b) that can be attached to garage door or entrances of a house or a storefront; as a warning sign [FIG. 11]; as a pizza delivery vehicle sign [FIG. 10] or a taxi sign; as an underwater messaging or display sign for marine use [FIG. 10b], such as used by divers to signal fellow divers [FIG. 13]. A sign according to the invention can be rolled up, enabling it to be used as a lantern as shown in FIG. 9 while at the same time providing storage ability inside a tube [FIG. 9a]. One of many advantages that a sign according to the invention possesses over related art is that such a sign is not restricted in use. That is, in an embodiment, a sign according to the invention does not require a bulky frame or prolonged attachment to a surface, but rather has the inherent capacity to be flexible [FIG. 9b], thus enabling a sign according to the invention to be carried by itself or to be attached reliably to a non-flat surface [FIG. 10a]. Another advantage over related art is that, in an embodiment, a sign according to the invention is immersible and waterproof, permitting such a sign to be used in a wider variety of conditions than signs known in the art. A further advantage that the invention possesses over related art is that, in an embodiment, a sign according to the invention is relatively lightweight. In an aspect of the invention, an embodiment of the invention remained illuminated even when the sandwich of sheets was rolled up into the shape of as scroll [FIG. 9]. In an aspect of the invention, an embodiment of the invention was found to be immersible and waterproof. In an aspect of the invention, a plurality of sheets of laminate material formed a clear pouch [FIG. 2] into which custom artwork was inserted for display against a luminescent background. This pouch is UV resistant to prevent the detonation of the inserted imagery and to protect the electroluminescent sheet. The unit is placed in a charging cradle when not in use [FIG. 14]. In an aspect of the invention, a tube to which the sandwich of sheets was affixed served also as a handle for display of the image to be displayed. The invention thus satisfies a long-felt need for a lightweight, waterproof, fully mobile and versatile, readily illuminated sign.

The foregoing description and embodiments are merely examples and are not intended to limit the scope of the invention, which encompasses all equivalents to what is described herein. Because one skilled in art will recognize obvious equivalents to the invention as described in this application, the invention itself relates to embodiments beyond what is disclosed verbatim and encompasses the entire range of equivalents to what is described above, which is by way of example only. Therefore only the principles of law and of equity limit the full scope to be accorded the following claims.

I claim:

1. An immersible, flexible, fully mobile, self contained and waterproof electroluminescent sign for vehicular or non-vehicular display of a textual, graphic, mixed, or other image, comprising: a sheet of electroluminescent material; a flexible laminate material, between layers of which the sheet is disposed; an inversion circuit, for excitation of the sheet and illumination of the image; and a self contained power supply, for supply of power to the inversion circuit housed in a heat dissipating enclosure.

2. An immersible, flexible, fully mobile, self contained and waterproof magnetic backed electroluminescent sign for vehicular or non-vehicular display of a textual, graphic, mixed, or other image, comprising: a sheet of electroluminescent material; a flexible laminate material, between layers of which the sheet is disposed; an inversion circuit, for excitation of the sheet and illumination of the image; and a power supply, for supply of power to the inversion circuit; wherein, while excitation of the sheet is ongoing, the sheet and the laminate material are susceptible of being rolled up into the shape of a scroll.

3. A sign according to claim 1, wherein the electroluminescent material is able to be formed, cut or segmented to assume a distinctive pattern that is recognizable as a graphic associated as a trademark with the goods or services provided by a commercial entity.

4. A sign according to claim 2, wherein the electroluminescent material is able to be formed, cut or segmented to assume a distinctive pattern that is recognizable as a graphic associated as a trademark with the goods or services provided by a commercial entity.
